(19) United States
(12) Patent Application Publication
(10) Pub. No.: US 2003/0160883 A1
(43) Pub. Date: Aug. 28, 2003

(54) Single chip cmos image sensor system with video compression

(76) Inventors: Viktor Ariel, Ramat-Gan (IL); Leon Altschul, Ramat-Gan (IL); German Voronov, Ramat-Gan (IL); Ilia Antsferov, Ramat-Gan (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/333,942

(22) PCT Filed: Sep. 12, 2001
(86) PCT No.: PCT/US01/29170

(51) Int. Cl. H04N 3/14; H04N 5/335

(52) U.S. Cl. 348/308; 348/302

(57) ABSTRACT

An imaging system (27) includes an optical path directing light to a CMOS imaging array (28), the output of which passes to an analog-to-digital converter (29). The array (27) and converter (28) perform their tasks under the control of readout control (32). The ADC (27) output is optionally passed through an image/color processing circuit (46), and thence to a memory (31). A motion estimator (33) reads data from the memory (31) and yields motion vectors communicated externally. Importantly, the motion estimator (33), the memory (31), the ADC (27), the readout control (32), and the imaging array (28) are all formed on a single integrated circuit chip. The memory (31) may also communicate image data externally. The system offer low power, a small parts count and a reduction in system volume compared to other systems.

This application claims priority from, and incorporates by reference, U.S. appl. No. 60/231,778 filed Sep. 12, 2000.

### BACKGROUND

There has been an extremely long-felt need for extremely compact imaging systems which accomplish substantial compression of video information and that do not consume too much power. To date, no existing system has optimized both requirements, particularly if a further constraint is imposed that the system be reasonable in cost. These needs show themselves particularly clearly where it is desired to provide portable wireless imaging. Challenges for such imaging include the low transmission bandwidth of wireless channels, the high power consumption of prior-art imaging devices, and the high cost of microchips needed for video processing. Image compression is an integral part of portable imaging systems because compression allows reduction of transmission bandwidth and power consumption of the whole system. Such compression, however, requires provision of much greater computational resources.

In an attempt to provide tolerable performance (from the point of view of a human user) given these many constraints and challenges, standards-setting bodies have developed low-bit-rate image compression standards, including MPEG-4, H.263, and H.26L. It has been apparent for some years, however, that currently available CCD (charge coupled device) and CMOS image sensors are not optimized for performance of image compression algorithms.

A typical prior-art solution has image compression performed in software, as shown in FIG. 3. This solution has an optical path 20 directing light to an imager 21 which is preferably a CMOS imager. The output of the imager 21 is communicated to a digital signal processor (DSP) 22 which performs the software computations needed for image processing and compression. The output of the DSP 22 is passed to a radio transmitter 23 to an antenna 24 which carries an RF (radio frequency) output.

This solution is inefficient and unworkable because the computations for MPEG-4 compression (a quarter common interchange format or QCIF picture at 10 frames per second or FPS) requires approximately 150 million instructions per second (MIPS). (QCIF is defined to be 144 lines and 176 pixels per line.) 150 MIPS is beyond the performance limits of the current generation of low-power DSP chips used in portable systems.

Another proposed system is shown in FIG. 4. In this system, an optical path 20 directs light to a CMOS imager 21. The output of the imager 21 is communicated to an image processing and video compression device 25, which may among other things provide a motion estimation function, the output of which passes to a digital signal processor (DSP) 26 which performs some of the baseband transmission functions. The output of the DSP 26 is passed to a radio transmitter 23 to an antenna 24 which carries an RF (radio frequency) output. A chief drawback of this approach is that it requires adding an extra microchip (the separate device 25) to perform image compression in real time. This offers severe drawbacks, including increased system size (the extra chip takes up space), and increased power consumption. The added parts count has drawbacks such as an additional assembly cost, an additional factory parts inventory count, and reduced system reliability.

### SUMMARY OF THE INVENTION

An imaging system includes an optical path directing light to a CMOS imaging array, the output of which passes to an analog-to-digital converter. The array and the converter perform their tasks (reading out of sensed light levels) as controlled by a readout control. The ADC output is optionally passed through an image/color processing circuit, and thence to a memory. A motion estimation accelerator reads data from the memory and yields motion vectors communicated externally. Importantly, the motion estimation accelerator, the memory, the ADC, the readout control, and the imaging array are all formed on a single integrated circuit chip. The memory also communicates image data externally. The system offers lower power, smaller parts count, and reduction in system volume as compared with other systems.

### DESCRIPTION OF THE DRAWING

The invention will be described with respect to a drawing in several figures, of which

FIG. 1 is a functional block diagram showing a transmitting system according to the invention;

FIG. 2 is a functional block diagram of a single-chip device used in the system of FIG 1;

FIG. 3 is a first prior-art unsatisfactory system; and

FIG. 4 is a second prior-art unsatisfactory system.

### DETAILED DESCRIPTION

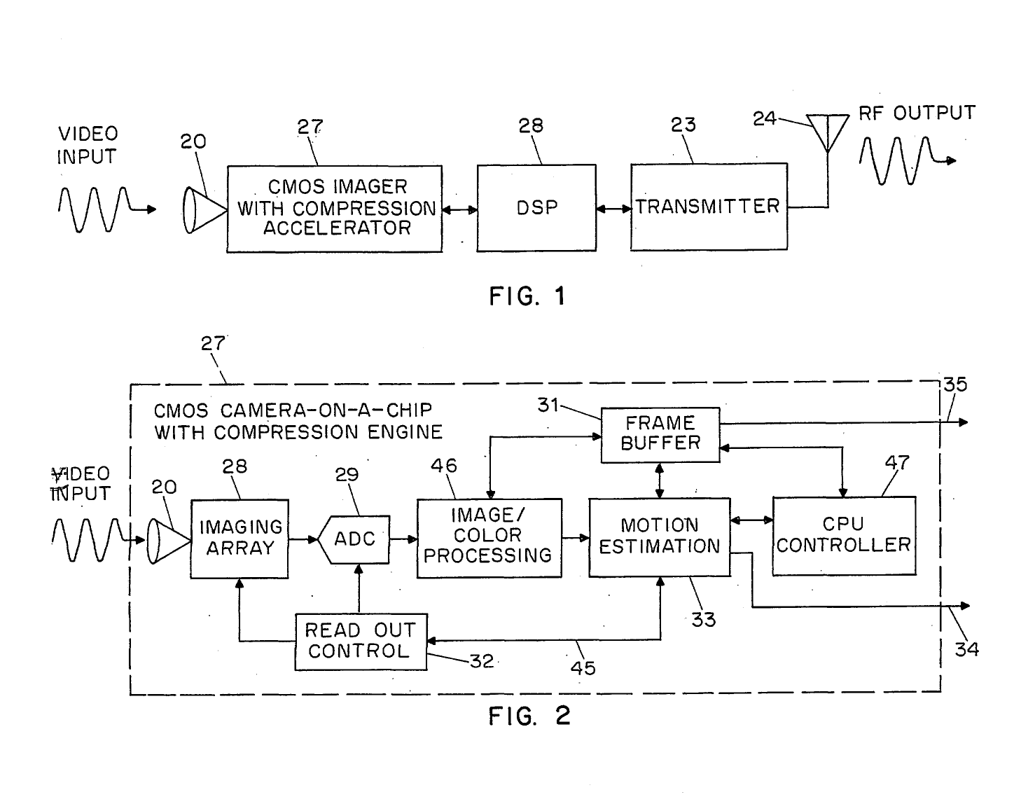

FIG. 1 is a functional block diagram showing a transmitting system according to the invention. In this system, an optical path 20 directs light to a single-chip imaging device 27 about which more will be said below, and which performs some of the computational burden for compression. Device 27 has an output which passes to the DSP 28, which performs some additional compression. The output from the DSP 28 goes to the transmitter 23, and thence to the antenna 24.

FIG. 2 is a functional block diagram of a single-chip device 27 used in the system of FIG. 1. In this device there is a a CMOS imaging array 28 having an output. In an exemplary embodiment, the array is an array of photodiodes, one per pixel. Associated with each photodiode are typically two or more transistors acting as an amplifier. For a color imaging array there, are color filters to permit separate collection of color information for each pixel. There is an optical path 20 nearby which is disposed to direct light upon the CMOS imaging array 28. There is an analog-to-digital converter 29 receiving the output of the CMOS imaging array 28, the analog-to-digital converter 29 formed on a single integrated circuit chip 27 with the CMOS imaging array 28 and having an output.

Also seen in FIG. 2 is a readout control 32 having outputs, the CMOS imaging array 28 and the analog-to-digital converter 29 each responsive to the outputs of the readout control 32 by reading out contents of the CMOS imaging array 28 and converting said contents from analog to digital signals at rates determined by the outputs of the readout control 32, the readout control 32 formed on the single integrated circuit chip 27 with the analog-to-digital converter 29.

Also seen in FIG. 2 is a memory 31, also called a frame buffer, receiving the digital signal output of the analog-to-digital converter 29, the memory 31 formed on the single integrated circuit clip 27 with the analog-to-digital converter 29. There is also a motion estimation accelerator 33, the motion estimation accelerator 33 communicatively coupled with the memory 32 and having a first output 45. In a preferred embodiment, the motion estimation is done in an ASIC (application specific integrated circuit) that is formed as part of the single-chip structure.

The readout control 32 is responsive to the first output 45 for modifying the readout procedure depending on the performance of the motion estimation accelerator 33.

The memory 31 and the motion estimation accelerator 33 each have respective outputs 35, 34 communicated external to the single integrated circuit chip 27, the respective output 34 of the motion estimation accelerator 33 comprising motion vectors.

In an exemplary embodiment, an image/color processing unit 46 provides image and color processing, with outputs to the memory 31 and to the motion estimation unit 33. Such processing includes establishing a good color balance taking into account the qualities of the pixel filters, establishing a white balance, and demosaicing. A processor 47 controls the memory 31 and motion estimation device 33 and optionally handles I/O (input/output) and other functions. An embedded core, it coordinates all the compression, including doing some of the compression computation. As a matter of the chip fabrication, the CPU is an embedded core formed on the chip.

Those skilled in the art will appreciate that historically it has been out of the question to try to provide all these functions on a single chip. This result can only be accomplished if one selects technologies that are capable of being fabricated on a single chip. Many CCD (charge-coupled-device) technologies are, for example, ill-suited for placement on a chip that also performs substantial computational tasks. In an exemplary embodiment, then, the imager 28 may be a CMOS imager, and the other functional blocks are CMOS devices.

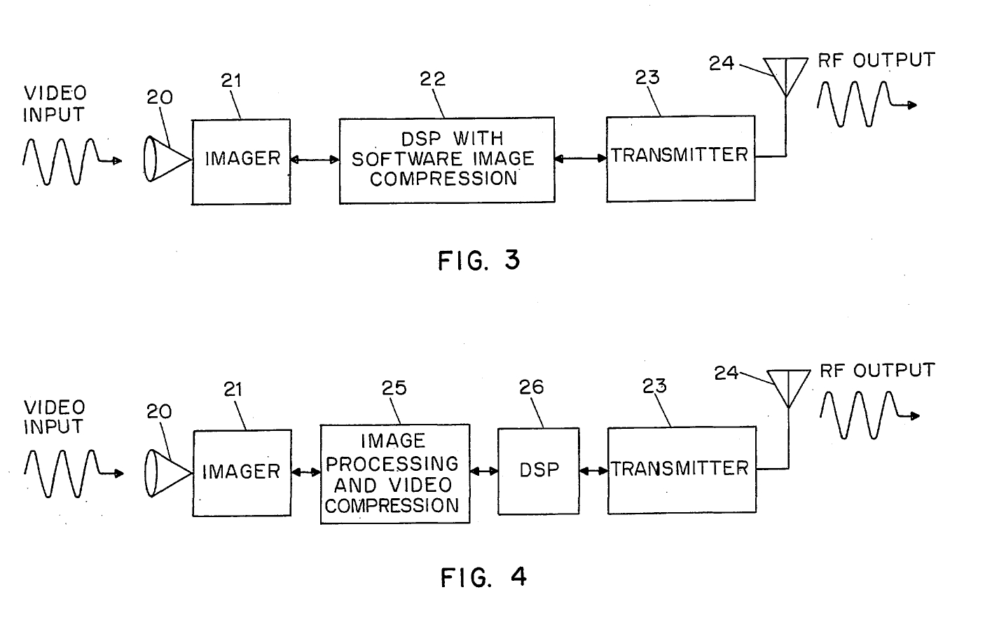

As will be appreciated, the long-felt need for a solution to this problem is answered by the invention described herein. The system has higher performance as compared with prior-art software approaches such as that shown in FIG. 3. The system occupies less space and consumes less power as compared with a dedicated motion estimation accelerator such as is shown in FIG. 4. The system allows feedback from the motion estimation accelerator to the readout control, which optimizes the performance of the motion estimation task.

What is claimed is:

1. A sensor comprising:
a CMOS imaging array having an output;
an optical path disposed to direct light upon the CMOS imaging array;
an analog-to-digital converter receiving the output of the CMOS imaging array, the analog-to-digital converter formed on a single integrated circuit chip with the CMOS imaging array and having an output;
a readout control having outputs, the CMOS imaging array and the analog-to-digital converter each responsive to the outputs of the readout control by reading out contents of the CMOS imaging array and converting said contents from analog to digital signals at rates determined by the outputs of the readout control, the readout control formed on the single integrated circuit chip with the analog-to-digital converter;
a memory receiving the digital signal output of the analog-to-digital converter, the memory formed on the single integrated circuit chip with the analog-to-digital converter; and
a motion estimation accelerator, the motion estimation accelerator communicatively coupled with the memory and having a first output;
said readout control responsive to the first output for modifying the readout procedure depending on the performance of the motion estimation accelerator;
said memory and said motion estimation accelerator each having respective outputs communicated external to the single integrated circuit chip, the respective output of the motion estimation accelerator comprising motion vectors.

2. A sensor comprising:
a CMOS imaging array having an output;
an optical path disposed to direct light upon the CMOS imaging array;
an analog-to-digital converter receiving the output of the CMOS imaging array, the analog-to-digital converter formed on a single integrated circuit chip with the CMOS imaging array and having an output;
a readout control having outputs, the CMOS imaging array and the analog-to-digital converter each responsive to the outputs of the readout control by reading out contents of the CMOS imaging array and converting said contents from analog to digital signals at rates determined by the outputs of the readout control, the readout control formed on the single integrated circuit chip with the analog-to-digital converter;
a memory receiving the digital signal output of the analog-to-digital converter, the memory formed on the single integrated circuit chip with the analog-to-digital converter; and
a motion estimation accelerator, the motion estimation accelerator communicatively coupled with the memory and having a first output;
a central processing unit communicatively coupled with the memory and with the motion estimation accelerator, the central processing unit formed on the single integrated circuit chip with the imaging array;
said readout control responsive to the first output for modifying the readout procedure depending on the performance of the motion estimation accelerator;
said memory and said motion estimation accelerator each having respective outputs communicated external to the single integrated circuit chip, the respective output of the motion estimation accelerator comprising motion vectors.

3. A method for imaging comprising the steps of:
receiving light on an imaging array formed on a chip;
performing analog-to-digital conversion of information from the array by means of an analog-to-digital converter formed on the chip;
performing image and color processing on digital information from the analog-to-digital converter by means of circuitry formed on the chip;
storing image-and-color-processed data in a frame buffer, the frame buffer formed on the chip;
performing motion estimation on the stored data by means of a motion estimation circuit, the motion estimation circuit formed on the chip;
performing readout of the imaging array and the analog-to-digital converter by means of a readout control circuit, the readout control circuit formed on the chip;
controlling the motion estimation circuit and the frame buffer by means of a processor, the processor formed on the chip.
